(19) United States
(12) Patent Application Publication
(10) Pub. No.: US 2004/0091397 A1
(43) Pub. Date: May 13, 2004

(54) Multiwell insert device that enables label free detection of cells and other objects

(75) Inventor: Laurent A.G. Picard, Corning, NY (US)

Correspondence Address: William J. Tucker, Attorney At Law, 8650 Southwestern Boulevard #3835, Dallas, TX, 75206-2668, US

(73) Assignee: Corning Incorporated

(21) Appl. No.: 10/290,001

(22) Filed: Nov. 7, 2002

(51) Int. Cl. B01L 3/00

(52) U.S. Cl. 422/99

(57) ABSTRACT

A multiwell insert device and method for using the multiwell insert device are described herein. The multiwell insert device includes an upper chamber, a lower chamber, a membrane and a sensor for detecting in a label-free manner an object (e.g., cells, molecules, proteins, drugs, chemical compounds, nucleic acids, peptides, carbohydrates) that passed through the membrane from the upper chamber into the lower chamber by measuring a change in a refractive index caused by the object being present on a surface of the lower chamber. The multiwell insert device can be used to perform a wide-variety of assays including, for example, cell migration assays and drug permeability assays. In addition, the multiwell insert device can form or be incorporated into a well of a microplate.

### BACKGROUND OF THE INVENTION

1. Field of the Invention

The present invention relates in general to a multiwell insert device and method for using the multiwell insert device that includes an upper chamber, a lower chamber, a membrane and a sensor for detecting in a label-free manner an object (e.g., cells, molecules, proteins, drugs, chemical compounds, nucleic acids, peptides, carbohydrates) that passed through the membrane from the upper chamber into the lower chamber by measuring a change in a refractive index caused by the object being present on a surface of the lower chamber.

2. Description of Related Art

During drug discovery development, approximately 39% of all new drugs fail in clinical studies because of adsorption, distribution, metabolism or excretion issues. As such, it is desirable to have an apparatus that allows a researcher to conduct these studies and evaluate these ADME parameters in vitro in an efficient, convenient and inexpensive fashion. Because they are relatively easy to handle and low in cost, multiwell insert devices are often used to conduct such studies. The traditional multiwell insert device includes an upper chamber that is separated from a lower chamber by a membrane. Traditional multiwell insert devices are sold by BD Biosciences under the brand name Multiwell Insert Plates and are also sold by Corning, Inc. under the brand name Transwell® Permeable Supports. Today these multiwell insert devices are used by researchers in two main applications.

The first application relates to cell migration assays. In these studies, cells are deposited in the upper chamber of the multiwell insert device and then allowed to migrate through the membrane into the lower chamber. Cells are then detected using fluorescent labels applied prior to the assay or by staining the cells at the end of the assay. Quantification is then performed by counting the stained cells or measuring the fluorescence in the lower chamber or on the membrane. For example, BD Bioscience has designed the BD BioCoat™ FluoroBlok™ Cell Culture Insert which has a membrane that allows detection of fluorescently labeled cells in the lower chamber without interference from labeled cells in the upper chamber. The main disadvantage associated with conducting cell migration assays using traditional multiwell insert devices is that the cells must be stained or fluorescently labeled, adding extra steps and extra cost to the experiments.

The second application relates to drug adsorption assays. Drug adsorption assays are performed to determine the permeability of one or more drugs across a biological membrane or a model membrane. Alternatively, the drug adsorption assay can be performed to determine the permeability of one or more drugs across Caco2 or MDCK cell monolayers (or any other appropriate cell lines) grown on a solid substrate (e.g., membrane, support filter) and separated with tight junctions. Typical detection methods used to quantify the amount of the drug in the lower chamber include: (1) liquid chromatography followed by mass spectrometry (LC/MS); and (2) UV visible spectrophotometry. The LC/MS method has the advantage of being easy to multiplex but also has the disadvantage of having a low throughput. The disadvantage of the UV visible spectrophotometry method is that it has a low throughput because the full spectrum needs to be recorded for each drug being studied. Another disadvantage of the LC/MS method and the UV visible spectrophotometry method is that they both are end-point assays.

Accordingly, there is and has been a need for a new type of multiwell insert device that can address the aforementioned shortcomings and other shortcomings of the traditional multiwell insert device. These needs and other needs are satisfied by the multiwell insert device of the present invention.

### BRIEF DESCRIPTION OF THE INVENTION

The present invention includes a multiwell insert device and method for using the multiwell insert device that includes an upper chamber, a lower chamber, a membrane and a sensor for detecting in a label-free manner an object (e.g., cells, molecules, proteins, drugs, chemical compounds, nucleic acids, peptides, carbohydrates) that passed through the membrane from the upper chamber into the lower chamber by measuring a change in a refractive index caused by the object being present on a surface of the lower chamber. The multiwell insert device can be used to perform a wide-variety of assays including, for example, cell migration assays and drug permeability assays. In addition, the multiwell insert device can form or be incorporated into a well of a microplate.

### BRIEF DESCRIPTION OF THE DRAWINGS

A more complete understanding of the present invention may be obtained by reference to the following detailed description when taken in conjunction with the accompanying drawings wherein:

FIGS. 1A-1B are respectively an exploded perspective view and a cross-sectional side view of a first embodiment of a multiwell insert device in accordance with the present invention;

FIGS. 1C-1D are respectively an exploded perspective view and a cross-sectional side view of a second embodiment of a multiwell insert device in accordance with the present invention;

FIGS. 1E-1F are respectively an exploded perspective view and a cross-sectional side view of a third embodiment of a multiwell insert device in accordance with the present invention;

FIG. 2 is a cross-sectional side view of the multiwell insert device shown in FIGS. 1A-1B that is being used to access the migration capacity of cells;

FIG. 3 is a cross-sectional side view of the multiwell insert device shown in FIG. 2 illustrating in greater detail a grating-based planar waveguide sensor used to detect the migrated cells;

FIG. 4 is a cross-sectional side view of the multiwell insert device shown in FIG. 2 illustrating in greater detail a grating-based planar waveguide sensor that utilizes an angular interrogation approach to detect the migrated cells;

FIG. 5 is a cross-sectional side view of the multiwell insert device shown in FIG. 2 illustrating in greater detail a grating-based planar waveguide sensor that utilizes a spectral interrogation approach to detect the migrated cells;

FIG. 6 is a cross-sectional side view of the multiwell insert device shown in FIG. 2 illustrating in greater detail a grating-based surface plasmon resonance (SPR) sensor used to detect the migrated cells;

FIG. 7 is a cross-sectional side view of the multiwell insert device shown in FIG. 2 illustrating in greater detail a prism-based surface plasmon resonance (SPR) sensor used to detect the migrated cells;

FIG. 8 is a cross-sectional side view of the multiwell insert device shown in FIGS. 1A-1B that is being used to access the adsorption or permeability of a drug;

FIG. 9 is a cross-sectional side view of the multiwell insert device shown in FIGS. 1A-1B that is being used to access in a multiplex format the adsorption or permeability of multiple drugs;

FIGS. 10A-10B respectively illustrate a perspective view and a cross-sectional side view of a microplate incorporating a plurality of multiwell insert devices shown in FIGS. 1A-1B; and

FIG. 11 is a flowchart illustrating the steps of a preferred method for using the multiwell insert device in accordance with the present invention.

### DETAILED DESCRIPTION OF THE DRAWINGS

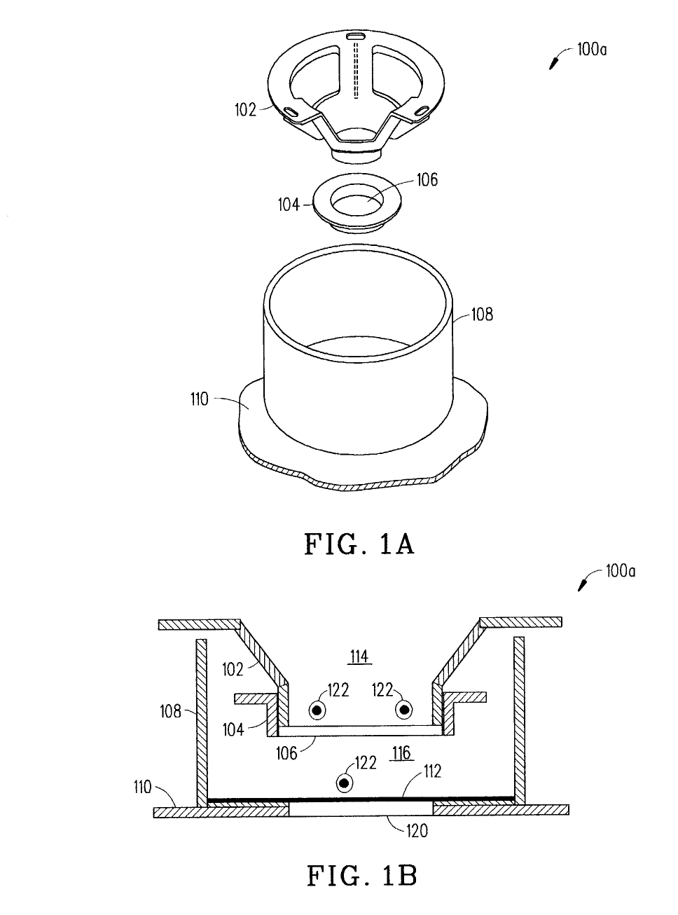

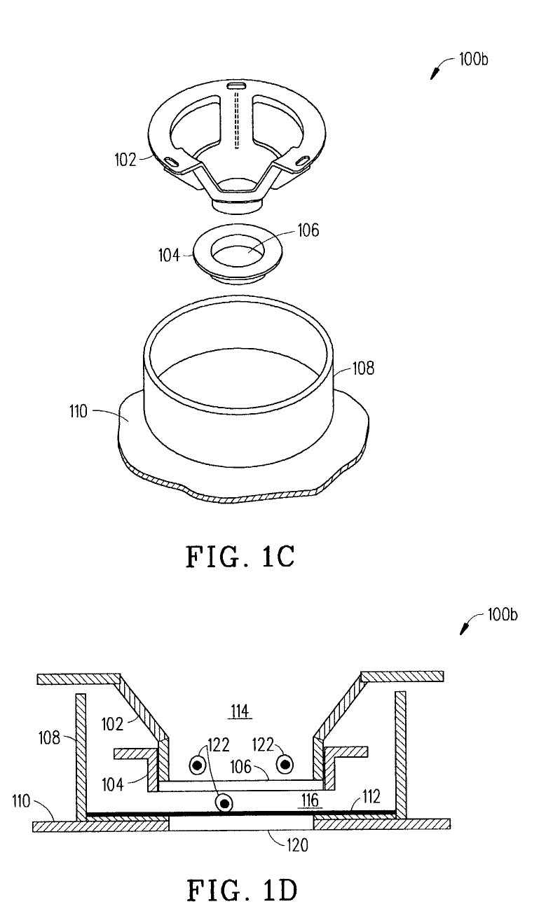

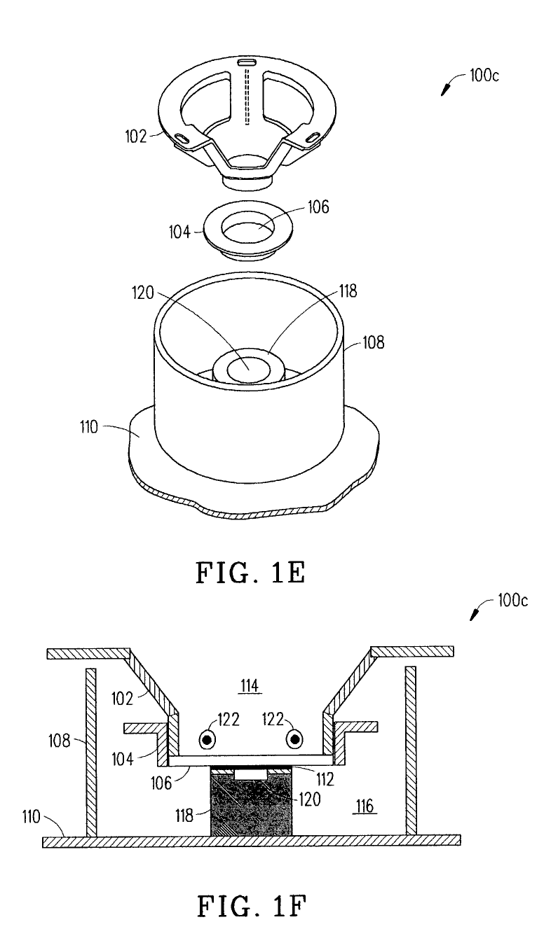

Referring to FIGS. 1-11, there are disclosed in accordance with the present invention several different embodiments of a multiwell insert device 100a, 100b and 100c and method 1100 for using the multiwell insert device 100a, 100b and 100c. Although the multiwell insert device 100a, 100b and 100c is described as being used to perform cell migration assays and drug permeability assays, it should be understood that the use of the multiwell insert device 100a, 100b and 100c is not limited to these studies. Instead, the multiwell insert device 100a, 100b and 100c can be used to perform a wide variety of studies including drug solubility studies, virus detection studies and protein secretion studies. Accordingly, the multiwell insert device 100a, 100b and 100c and the method 1100 for using the multiwell insert device 100a, 100b and 100c should not be construed in a limited manner.

FIGS. 1A-1F include three sets of exploded perspective views and cross-sectional side views of three different embodiments of the multiwell insert device 100a, 100b and 100c in accordance with the present invention. Each multiwell insert device 100a, 100b and 100c has a hanger 102 that detachably supports a retention element 104. The retention element 104 in turn detachably supports a membrane 106. The hanger 102 is constructed and arranged so that it may be suspended from a rim of a well 108 in a culture dish 110.

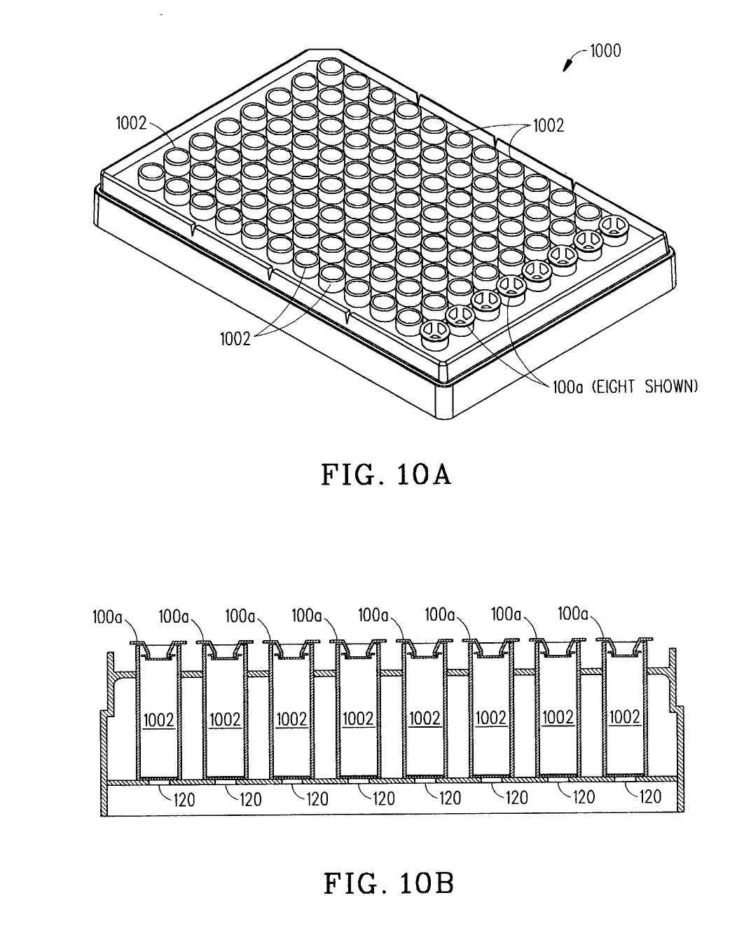

The culture dish 110 as shown has only one well 108, but it is to be appreciated that the culture dish 110 may have six, twelve, twenty-four or some other number of wells 108 (see, e.g., the microplate 1000 in FIG. 10). It should also be appreciated that the multiwell insert device 100a, 100b and 100c can be constructed in various sizes and shapes and still be considered within the scope of the present invention. For example, as shown in FIGS. 1A-1B, the hanger 102 may support the retention element 104 and membrane 106 relatively far from a surface 112 of the culture dish 110. Or as shown in FIGS. 1C-1D, the hanger 102 may support the retention element 104 and membrane 106 relatively close to the surface 112 of the culture dish 110. Alternatively as shown in FIGS. 1E-1F, the culture dish 110 may have a pillar 118 extending up into the well 108 that is relatively close to and may even contact the membrane 106.

The multiwell insert device 100a, 100b and 100c further includes a sensor 120 that detects in a label-free or independent manner an object 122 (e.g., cell(s), molecule(s), protein(s), drug(s), chemical compound(s) nucleic acid(s), peptide(s), carbohydrate(s)) that was deposited within a solution in an upper chamber 114 and allowed to pass through the membrane 106 into a lower chamber 116. In particular, the sensor 120 detects the object 122 located on or near the surface 122 of the lower chamber 116. The upper chamber 114 is defined by the area within the hanger 102 and above the membrane 106. And, the lower chamber 116 is defined by the area outside the hanger 102 and the area below the membrane 106 but within the walls of the well 108.

The sensor 120 detects in a label-free or independent manner the presence of the object 122 in the lower chamber 116 by measuring a change in a refractive index caused by the presence of the object 122 on or near the surface 112. For example, the sensor 120 would measure one value for the refractive index when the object 122 is not present on the surface 112 and then measure another value for the refractive index when the object 122 is present on the surface 112. A difference in these measured refractive indexes would indicate that the object 122 is present on the surface 112. Moreover, one can use the multiwell insert device 100a, 100b and 100c to determine the amount or mass of the object 122 present on the surface 112. Several different types of sensors 120 are described below with respect to FIGS. 3-7.

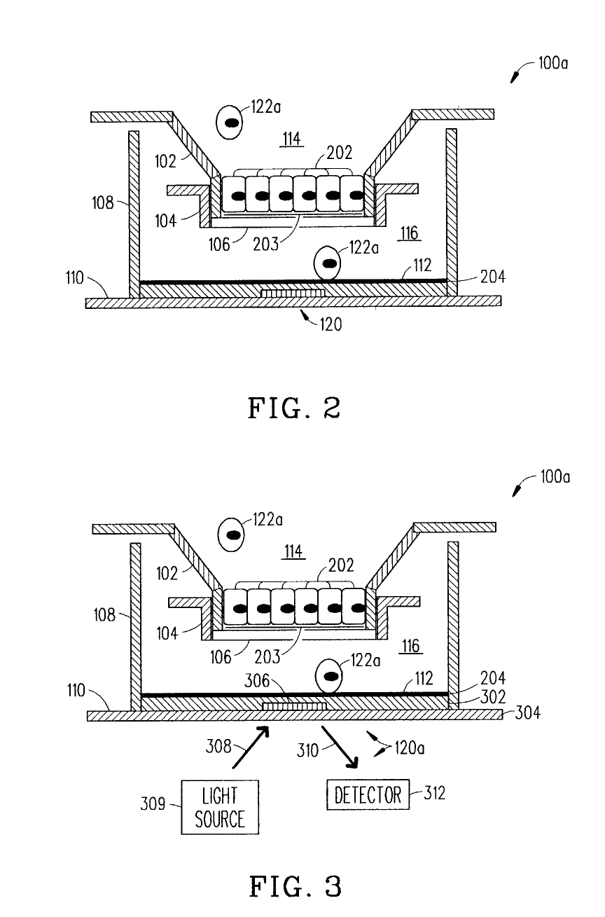

Referring to FIG. 2, there is a cross-sectional side view of the multiwell insert device 100a that is being used to access the migration capacity of cells 122a. Basically, the multiwell insert device 100a and the sensor 120 incorporated therein use label-free detection technology to assess the migration capacity of cells 122a. To accomplish this, the sensor 120 measures the refractive index on the surface 112 of the lower chamber 116 before and after the cells 122a are allowed to migrate from the upper chamber 114 through the membrane 106 and then concentrate on the surface 112 in the lower chamber 116. A change in the refractive index would indicate the presence of the cells 122a. The capability of the multiwell insert device 100a to asses the migration capacity of cells 122a in this manner is a marked improvement over the traditional multiwell insert device in which the cells had to be stained or fluorescently labeled in order to assess their migration capacity.

As described above, the multiwell insert device 100a includes the upper chamber 114 and the lower chamber 116 which are defined by the areas around or within the hanger 102 and membrane 106. The membrane 106 can be made from polyester, polycarbonate or any other porous material that has a wide range of pore sizes such as 0.1 μm to 12.0 μm. In addition, the membrane 106 may be coated with Caco2 or MDCK cells 202 (other immortalized cell lines or primary cells can of course also be used) and/or a biochemical layer 203 (e.g., collagen, fibronectin, growth factors, extra-cellular matrix (ECM) proteins).

To perform cell migration assays, the researcher would deposit cells 122a in the upper chamber 114 along with a solution and allow the cells 122a to migrate through the cell monolayer 202 and/or the biochemical/protein coating 203 (if any) and the membrane 106 into the lower chamber 116. After migration through the cell monolayer 202 and/or the biochemical/protein coating 203 (if any) and the membrane 106, the cells 122a fall by gravity onto the surface 112 of the lower chamber 116. The surface 112 can be coated with a specific surface chemistry coating 204 that favors the capture and concentration of cells 122a. For example, the surface chemistry coating 204 can include hydrophobic, hydrophilic or charged surface chemistries, it can also be a capture reagent such as an antibody or a mixture of antibodies that enable multiplex assays and also enables the detection of cells 122a that have different surface antigens. Then, the cells 122a are detected on the surface 112 of the lower chamber 116 by using the sensor 120 that detects a change in the refractive index caused by the presence of the cells 122a. Again, several different types of sensors 120 that can be used in the multiwell insert device 100a are described in greater detail below with respect to FIGS. 3-7.

Referring to FIG. 3, there is a cross-sectional side view of the multiwell insert device 100a which has incorporated therein a grating-based planar waveguide sensor 120a. Basically, the grating-based planar waveguide sensor 120a is an optical biosensor which makes use of the refractive and coupling properties of light to detect the presence of cells 122a on the surface 112 of the lower chamber 116.

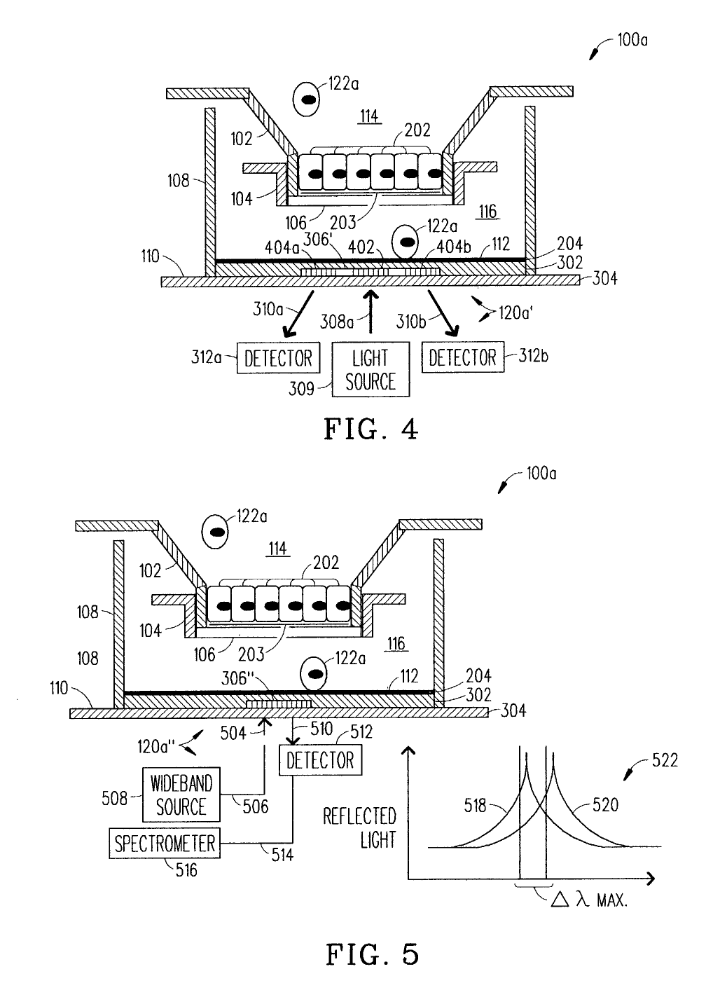

The grating-based planar waveguide sensor 120a as shown includes a waveguide 302 that forms the surface 112 which is contacted by cells 122a if there is no surface chemistry coating 204. The waveguide 302 is preferably made of metal-oxide based materials such as TaₛO₅, TiOₛ, TiO₂—SiO₂, HfO₂, ZrO₂, Al₂O₃, Si₃N₄, HfON, SiON, scandium oxides or mixtures thereof. A substrate 304, which has a lower refractive index than the waveguide 302, is adjacent to and located below the waveguide 302. The substrate 304 is preferably made of glass or plastic such as polycarbonate. A diffraction grating 306 which is embossed in plastic, micro-replicated in plastic, etched in glass or made by other state-of-the-art processes within the substrate 304 and then coated with the waveguide 302. In particular, the diffraction grating 306 is positioned to in-couple light 308 that is shone by a light source 309 on the substrate 304 and then out-couple light 310 to a detector 312. Changes in the refractive index of the waveguide 302 caused by presence of the cells 122a on the surface 112 can be detected by observing changes in the out-coupled light 310 at the detector 312. The grating-based planar waveguide sensor 120a can operate using several different approaches including, for example, the angular interrogation approach and the spectral interrogation approach both of which are described below with respect to FIGS. 4 and 5.

Referring to FIG. 4, there is a cross-sectional side view of the multiwell insert device 100a which has incorporated therein the grating-based planar waveguide sensor 120a′ that utilizes the angular interrogation approach to detect the migrated cells 122a. In this approach, the diffraction grating 306′ includes one discrete in-coupling grating 402 and two discrete out-coupling gratings 404a and 404b. The diffraction grating 306′ can cover the whole surface 112 or only a part of the surface 112 (as shown). The diffraction grating 306′ and in particular the in-coupling grating 402 is positioned to cooperate with the substrate 304 and in-couple light 308a that is shone by a light source 309 on the substrate 304. The out-coupling gratings 404a and 404b then respectively out-couple light 310a and 310b that is monitored by detectors 312a and 312b. Changes in the refractive index of the waveguide 302 caused by presence of the cells 122a on the surface 112 are detected by observing changes in the out-coupled light 310a and 310b at the detectors 312a and 312b. Alternatively, it should be noted that angular interrogation can also be performed with a single grating the performs both the in-coupling and the out-coupling functions. In yet another alternative, the angular interrogation can be performed with an in-coupling grating and only one out-coupling grating. Referring to FIG. 5, there is a cross-sectional side view of the multiwell insert device 100a which has incorporated therein the grating-based planar waveguide sensor 120a″ that utilizes the spectral interrogation approach to detect the migrated cells 122a. In this approach, the diffraction grating 306″ can cover the whole surface 112 or only a part of the surface 112 (as shown). The diffraction grating 306″ is positioned to cooperate with the substrate 304 and in-couple light 504 that is shone on the substrate 304. For example, the light 504 can be emitted from a fiber 506 connected to a wideband source 508 (e.g., multi-channel wideband source 508). The diffraction grating 306″ then out-couples light 510 to a detector 512 (e.g., multi-channel read head 512) which is connected via a fiber 514 to a spectrometer 516. Changes in the refractive index of the waveguide 302 caused by the presence of the cells 122a on the surface 112 can be detected by observing changes in the wavelength of out-coupled light 510 at the detector 512. In particular, the spectrometer 514 can detect the presence of the cells 122a on the surface 112 when there is a difference in the wavelength 518 measured before the presence of migrated cells 122a and the wavelength 520 measured after the presence of migrated cells 122a. This difference between wavelengths 518 and 522 is shown in graph 522. It should be appreciated that the spectral interrogation approach is amenable to the imaging and detection of discrete spots on an array.

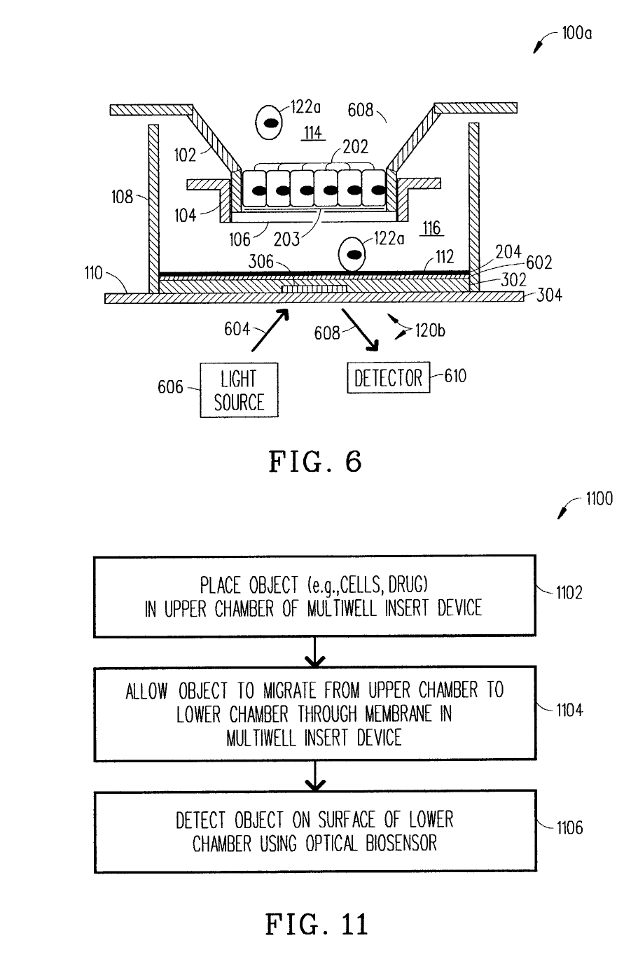

Referring to FIG. 6, there is a cross-sectional side view of the multiwell insert device 100a which has incorporated therein a grating-based surface plasmon resonance (SPR) sensor 120b used to detect the migrated cells 122a. Basically, the grating-based SPR sensor 120b is an optical biosensor which makes use of the Surface Plasmon Resonance phenomenon and the refractive properties of light to detect the presence of the cells 122a on the surface 112 of the lower chamber 116.

The grating-based SPR sensor 120b as shown includes a support layer 302 (e.g., waveguide 302) that is coated with a noble metal 602 such as gold. The surface chemistry coating 204 (if any) which forms the surface 112 is located above the noble metal 602 and the support layer 302. The noble metal 602 and the diffraction grating 306 can cover the whole surface 112 or only a part of the surface 112. The diffraction grating 306 is positioned to in-couple light 604 that is shone from a light source 606 onto the diffraction grating 306. The out-coupled light 608 is then monitored by a detector 610 (e.g., CCD camera 610). Changes in the refractive index at the surface and plasmon generated by the noble metal 602 caused by the presence of the cells 122a on the surface 112 are detected by observing changes in the out-coupled light 608 at the detector 610. It should be appreciated that this detection approach is a spectral interrogation approach and as such is amenable to the imaging and detection of discrete spots on an array.

Referring to FIG. 7, there is a cross-sectional side view of the multiwell insert device 100a which has incorporated therein a prism-based surface plasmon resonance (SPR) sensor 120c used to detect the migrated cells 122a. Like the grating-based SPR sensor 120b, the prism-based SPR sensor 120c is an optical biosensor which makes use of the evanescent-wave phenomenon and the refractive properties of light to detect the presence of the cells 122a on the surface 112. However, the prism-based SPR sensor 120c uses a prism 702 to accomplish this instead of a diffraction grating 306 like in the grating-based SPR sensor 120b.

The prism-based SPR sensor 120c as shown includes a support layer 302 that is coated with a noble metal 602 such as gold. The surface chemistry coating 204 (if any) which forms the surface 112 is located above the noble metal 602 and the support layer 302. A light source 704 is positioned to in-couple light 706 into the prism 702 that is contacting the bottom of the substrate 304. The out-coupled light 708 is then monitored by a detector 710. Changes in the refractive index in the immediate vicinity near the top of the surface 112 and the plasmon generated within the noble metal 602 caused by the presence of the cells 122a on the surface 112 are detected by observing changes in the out-coupled light 708 at the detector 710. In particular, the detector 710 detects the presence of the cells 122a on the surface 112 when there is a sharp shadow in the reflected light 708 from the surface 112 that is at an angle dependent on the amount or mass of cells 122a on the surface 112. As shown in graph 714, the angle shifts from I to II when the cells 122a migrate to the surface 112 and change the mass on the surface 112. This change in the resonant angle is monitored non-invasively and in real-time as a plot of resonance signal (proportional to mass change) versus time as shown in graph 716.

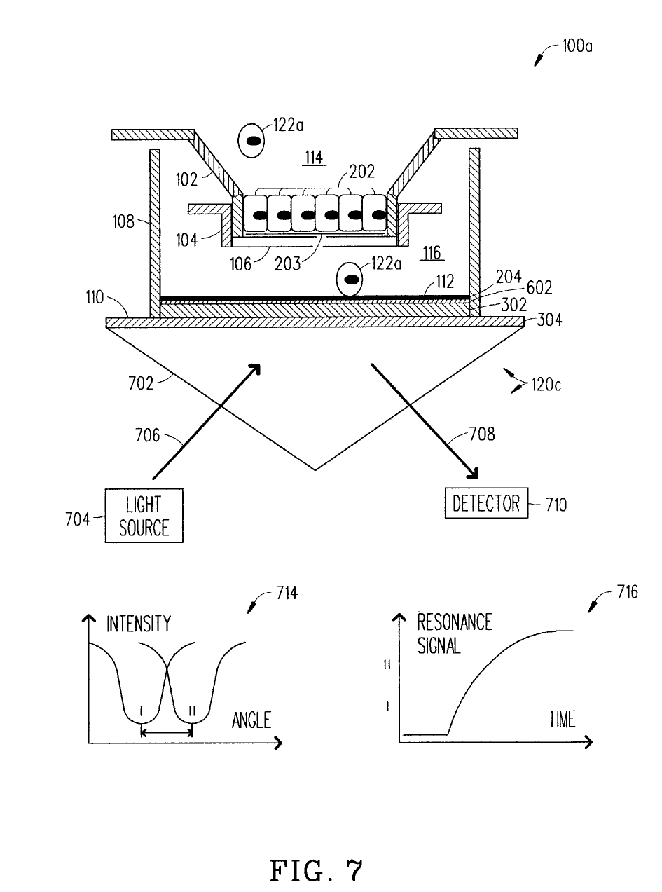

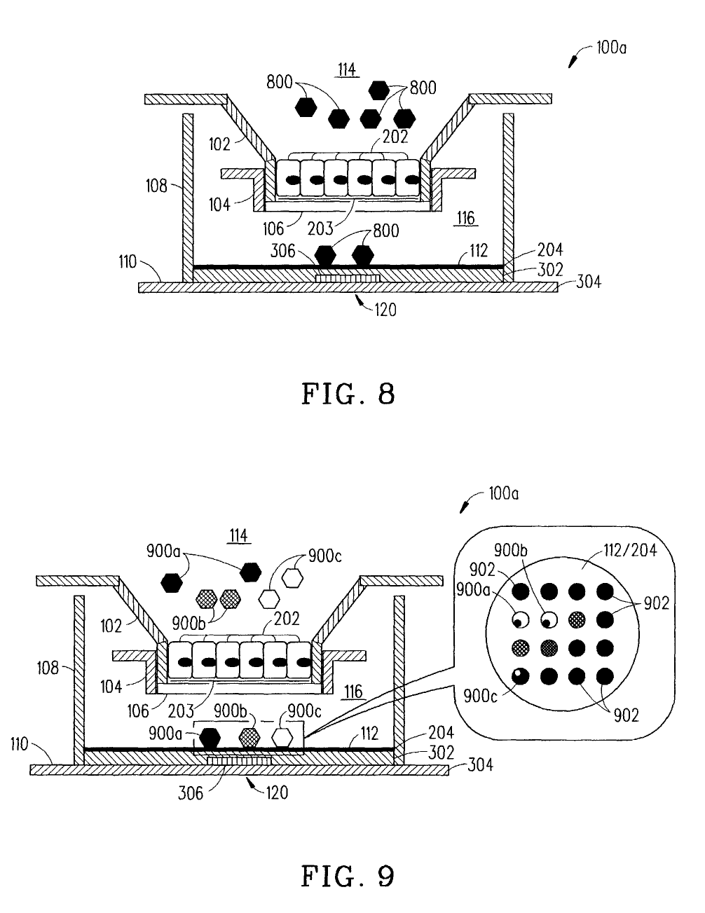

Referring to FIG. 8, there is a cross-sectional side view of the multiwell insert device 100a that is being used to access the adsorption or permeability of a drug 800 (i.e., chemical compound 800). Basically, the multiwell insert device 100a and the sensor 120 incorporated therein use label-free detection technology to assess the adsorption of the drug 800 by measuring the permeability of the drug 800 through the biological/model membrane (not shown) or cell monolayer 202 in the presence or absence of the biological coating 203 located on the membrane 106. To accomplish this, the sensor 120 measures the refractive index on the surface 112 of the lower chamber 116 before and after the drug 800 is allowed to migrate from the upper chamber 114 through the membrane 106 and then concentrate on the surface 112. Like above, the surface 112 can be coated with a surface chemistry coating 204 that has or does not have capture reagents which favors the capture and concentration of the drug 800 at the surface 112 (e.g., hydrophilic, hydrophobic or charged surface 112). For example, the surface chemistry coating 204 can be serum proteins such as the human serum albumin so that binding to these proteins (an important ADME property) can be assessed at the same time. In another example, the surface chemistry coating 204 can be proteins such as CYP450 enzymes that can be used to assess potential toxicity or drug interactions of the drug 800. Other surface chemistry coatings 204 include antibodies, aptamers, plasma proteins and other protein coatings, or capture reagents such as cells, proteins, nucleic acids, carbohydrates (for example).

Alternatively, the drug adsorption studies can be performed by measuring the binding of the drug 800 to the cells 202 and/or the biological coating 203 and the membrane 106 in which case the sensor 120 would typically be located near the membrane 106 as shown in FIG. 1F. To avoid repetition, the configuration of the multiwell insert device 100a and the different types of sensors 120 that can be used to access the adsorption of the drug 800 are not described in detail in this section since they have already be described above with respect to FIGS. 3-7.

Referring to FIG. 9, there is a cross-sectional side view of the multiwell insert device 100a that is being used to assess in a multiplex format the adsorption or permeability of multiple drugs 900a, 900b, 900c . . . (e.g., chemical compounds 900a, 900b, 900c). The multiwell insert device 100a in this embodiment has the same structure and types of sensors 120 as the multiwell insert device 100a described above with respect to FIG. 8. However, the multiwell insert device 100a in this embodiment can be used in mutliplex assays since the surface 112 is coated with a surface chemistry coating 204 that has an array of antibodies 902 (or other capture reagents or surface chemistries) that can specifically detect a drug 900a, 900b or 900c or a mixture of drugs 900a, 900b and 900c. Typically, the antibodies 902 or any other objects (e.g., capture reagents, surface chemistries proteins, nucleic acids) spotted in array has spots that are approximately 150 μm in diameter and have a 220 μm pitch approximately (see enlarged top view of surface 112).

Referring to FIGS. 10A-10B, there are respectively illustrated a perspective view and a cross-sectional side view of a microplate 1000 incorporating a plurality of multiwell insert devices 100a shown in FIGS. 1A-1B. The microplate 1000 includes an array of wells 1002 each of which has the form of the multiwell insert device 100a. The wells 1002 are generally arranged in a matrix of mutually perpendicular rows and columns. For example, the microplate 1000 can include a matrix of wells 1002 having dimensions of 4×6 (24 wells), 8×12 (96 wells) and 16×24 (384 wells). The microplate 1000 shown includes an array of ninety-six wells 1002.

Referring to FIG. 11, there is a flowchart illustrating the steps of a preferred method 1100 for using the multiwell insert device 100a. Although the multiwell insert device 100a is described herein as being used to perform cell migration assays and drug permeability assays, it should be understood that the use of the multiwell insert device is not limited to these studies. Instead, the multiwell insert device 100a can be used to perform a wide variety of studies including drug solubility studies, virus detection studies and protein secretion studies.

Beginning at step 1102, the multiwell insert device 100a is prepared by depositing an object 122 (e.g., cells 122a, molecules, proteins, drug 800, drugs 900a, 900b and 900c, chemical compound or chemical compounds) and solution in the upper chamber 114. Of course, it is assumed that the membrane 106 including, for example, the cells 202 and/or biological coatings 203 have already been prepared before performing step 1102. At step 1104, the object 122 is allowed to migrate from the upper chamber 114 to the lower chamber 116 through the biochemical coating 202 (if any) and the membrane 106. As described above, the membrane 106 can be polyester, polycarbonate or any other porous material that has a wide range of pore sizes such as 0.1 μm to 12.0 μm. At step 1106, the object 122 which has fallen by gravity or with the aid of centrifugation, aspiration, electrical field, magnetic field . . . onto the surface 112 is detected in a label-free manner by the sensor 120 which measures a change in the refractive index caused by the object 122 being present on the surface 112. As described above, the sensor 120 detects the presence of the object 122 on the surface 112 by measuring one value for the refractive index when the object 122 is not present on the surface 112 and then measuring another value for the refractive index when the object 122 is present on the surface 112. A difference in these measured refractive indexes would indicate that the object 122 is present on the surface 112. Moreover, one can use the multiwell insert device 100a to determine the amount or mass of the object 122 present on the surface 112. Several different types of exemplary sensors 120 have been described above with respect to FIGS. 3-7.

Although FIGS. 2-11 show the multiwell insert device 100a, it should be appreciated that different configurations of the multiwell insert device could have been used in these FIGURES including, for example, the aforementioned multiwell insert devices 100b and 100c. In addition, for a more detailed discussion about the different types of sensors 120 that can be used in the present invention reference is made to an article by M. A. Cooper entitled “Optical Biosensors in Drug Discovery”, Nature Reviews Drug Discovery, Vol. 1, pp. 515-28, July 2002. This article is hereby incorporated by reference herein.

Following are some advantages and uses of the multiwell insert device 100a, 100b and 100c:

The multiwell insert device 100a, 100b and 100c can be used to study a wide range of assays including, for example, tumour invasions in cancer, endothelial cell migration in angionesis and chemoattraction in inflammation.

The multiwell insert device 100a, 100b and 100c enables the in vitro evaluation of ADME parameters for lead compounds in high throughput screening applications.

The multiwell insert device 100a, 100b and 100c enables the assessment of the solubility of objects 122 using high-throughput methods during the lead optimization phase of drug discovery.

The multiwell insert device 100a, 100b and 100c used in cell migration assays eliminates the need to label cells with fluorescent dye and can provide a real-time measurement of the cell migration.

The multiwell insert device 100a, 100b and 100c used in drug permeability assays leads to an increase in throughput and provides a real-time measurement of the drug permeability.

The multiwell insert device 100a, 100b and 100c can be used in drug solubility studies. In this application, the multiwell insert device 100a, 100b and 100c can be used with or without the hanger 102 and membrane 106. For example, the objects 122 (e.g., chemical compounds) would be diluted in a solution at different concentrations and different pHs and then their solubility is assessed in real-time by the change of refractive index at the surface 112 or in bulk near the surface 112.

The multiwell insert device 100a, 100b and 100c can use SPR, SPR imaging, diffraction gratings couplings or other direct measures such as optical methods, thermal or electrochemical detections to enable the label-free detection of objects 122.

The multiwell insert device 100a, 100b and 100c can incorporate a diffraction grating that covers the whole surface 112 or only a part of the surface 112 of the lower chamber 116.

The multiwell insert device 100a, 100b and 100c can be used in other studies such as:

Drug solubility studies.

Virus studies including but not limited to titration, migration or virus production monitoring.

Microbiology studies for bacteria or other microbes.

Protein secretion detection studies.

Primary cells migration and differentiation, in vitro fertilization studies.

High-throughput studies such as ADME-Tox, gene therapy, protein production, pharmaceutical QC, diagnostics, food safety testing, environment, biological warfare agent detection . . . .

Although several embodiments of the present invention has been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A multiwell insert device, comprising:
an upper chamber;
a lower chamber;
a membrane located between said upper chamber and said lower chamber; and
a sensor for detecting an object that passed through said membrane from said upper chamber into said lower chamber by measuring a change in a refractive index caused by the object being present on a surface of said lower chamber.

2. The multiwell insert device of claim 1, wherein said object is a cell, molecule, protein, drug, chemical compound, nucleic acid, peptide or carbohydrate.

3. The multiwell insert device of claim 1, wherein said sensor is used to assess the migration capacity of the objects through said membrane.

4. The multiwell insert device of claim 1, wherein said sensor is used to assess the attachment capacity of the object on said membrane.

5. The multiwell insert device of claim 1, wherein said membrane is a polyester membrane or a polycarbonate membrane.

6. The multiwell insert device of claim 1, wherein said membrane is a microporous membrane with pores in the range of 0.1 μm to 12.0 μm.

7. The multiwell insert device of claim 1, wherein said membrane is coated with a biochemical component, protein, biological membrane or cells.

8. The multiwell insert device of claim 1, wherein said surface of said lower chamber is coated with at least one substance that favors the capture and concentration of said object at the surface of said lower chamber.

9. The multiwell insert device of claim 1, wherein said surface of said lower chamber is coated with a capture reagent including an antibody or other binding proteins.

10. The multiwell insert device of claim 1, wherein said surface of said lower chamber is coated with a capture reagent including hydrophobic, hydrophilic or charged surface chemistries.

11. The multiwell insert device of claim 1, wherein said sensor is a grating-based planar waveguide sensor.

12. The multiwell insert device of claim 11, wherein said grating-based planar waveguide sensor utilizes an angular interrogation approach to detect the object.

13. The multiwell insert device of claim 11, wherein said grating-based planar waveguide sensor utilizes a spectral interrogation approach to detect the object.

14. The multiwell insert device of claim 1, wherein said sensor is a grating-based surface plasmon resonance sensor.

15. The multiwell insert device of claim 1, wherein said sensor is a prism-based surface plasmon resonance sensor.

16. The multiwell insert device of claim 1, wherein a plurality of said multiwell insert devices form a plurality of wells in a microplate.

17. The multiwell insert device of claim 1, wherein said lower chamber is shallow compared to said upper chamber.

18. The multiwell insert device of claim 1, wherein said sensor contacts said membrane.

19. A method for using a multiwell insert device, said method comprising the steps of:
placing an object in an upper chamber of said multiwell insert device;
allowing the object to migrate from the upper chamber to a lower chamber through a membrane of said multiwell insert device; and
detecting the object on a surface of the lower chamber using a sensor that measures a change in a refractive index caused by the object being present on a surface of the lower chamber.

20. The method of claim 19, wherein said object is a cell, molecule, protein, drug, chemical compound, nucleic acid, peptide or carbohydrate.

21. The method of claim 19, wherein said sensor is used to assess the migration capacity of the object through said membrane.

22. The method of claim 19, wherein said sensor is used to access the attachment capacity of the object on said membrane.

23. The method of claim 19, wherein said membrane is a polyester membrane or a polycarbonate membrane.

24. The method of claim 19, wherein said membrane is a microporous membrane with pores in the range of 0.1 μm to 12.0 μm.

25. The method of claim 19, wherein said membrane is coated with a biochemical component, protein, biological membrane or cells.

26. The method of claim 19, wherein said surface of the lower chamber is coated with at least one substance that favors the capture and concentration of said object at a surface of the lower chamber.

27. The method of claim 19, wherein said surface of said lower chamber is coated with a capture reagent including an antibody or other binding proteins.

28. The method of claim 19, wherein said surface of said lower chamber is coated with a capture reagent including hydrophobic, hydrophilic or charged surface chemistries.

29. The method of claim 19, wherein said sensor is a grating-based planar waveguide sensor.

30. The method of claim 29, wherein said grating-based planar waveguide sensor utilizes an angular interrogation approach to detect the object.

31. The method of claim 29, wherein said grating-based planar waveguide sensor utilizes a spectral interrogation approach to detect the object.

32. The method of claim 19, wherein said sensor is a grating-based surface plasmon resonance sensor.

33. The method of claim 19, wherein said sensor is a prism-based surface plasmon resonance sensor.

34. The method of claim 19, wherein a plurality of said multiwell insert devices form a plurality of wells in a microplate.

35. The method of claim 19, wherein said lower chamber is shallow compared to said upper chamber.

36. The method of claim 19, wherein said sensor contacts said membrane.

37. A microplate, comprising:
a frame including a plurality of wells formed therein, each well is in the form of a multiwell insert device that includes:
an upper chamber;
a lower chamber;
a membrane located between said upper chamber and said lower chamber; and
a sensor for detecting an object that passed through said membrane from said upper chamber into said lower chamber by measuring a change in a refractive index caused by the object being present on a surface of said lower chamber.

38. The microplate of claim 37, wherein said object is a cell, molecule, protein, drug, chemical compound, nucleic acid, peptide or carbohydrate.

39. The microplate of claim 37, wherein said sensor is used to assess migration capacity of the object through said membrane.

40. The microplate of claim 37, wherein said sensor is used to access the attachment capacity of the object on said membrane.

41. The microplate of claim 37, wherein said sensor is used to perform multiplex assays.

42. The microplate of claim 37, wherein said sensor is a grating-based planar waveguide sensor.

43. The microplate of claim 37, wherein said sensor is a grating-based surface plasmon resonance sensor.

44. The microplate of claim 37, wherein said sensor is a prism-based surface plasmon resonance sensor.
